(19) United States
(12) Patent Application Publication
(10) Pub. No.: US 2015/0197087 A1
(43) Pub. Date: Jul. 16, 2015

(54) PRINT CONTROL APPARATUS, PROGRAM, AND IMAGE PROCESSING METHOD

(71) Applicant: SEIKO EPSON CORPORATION, Tokyo (JP)

(72) Inventor: Kenichi HONDA, Matsukawa-mura (JP)

(21) Appl. No.: 14/564,527

(22) Filed: Dec. 9, 2014

(30) Foreign Application Priority Data
Jan. 10, 2014 (JP) 2014-003001

(51) Int. Cl. B41J 2/045; B41J 2/21

(52) U.S. Cl. CPC B41J 2/04595; B41J 2/21

(57) ABSTRACT

A print control apparatus configured to generate first printed image data indicative of positions of first dots formed by a first ink and second printed image data indicative of positions of second dots formed by a second ink, and configured to cause a print apparatus to discharge the first ink and the second ink to form the first dots and the second dots on a medium, wherein the first printed image data and the second printed image data are generated such that a preferential direction in which the first dots are generated in the first printed image data and a preferential direction in which the second dots are generated in the second printed image data are different from each other.

### CROSS-REFERENCE TO RELATED APPLICATIONS

This application claims priority to Japanese Patent Application No. 2014-003001 filed on Jan. 10, 2014. The entire disclosure of Japanese Patent Application No. 2014-003001 is hereby incorporated herein by reference.

### BACKGROUND

1. Technical Field

The present invention relates to a print control apparatus, program, and image processing method.

2. Related Art

A print apparatus (for example, a printer) for discharging ink onto a medium (for example, paper) and printing an image on the basis of printed image data is known. A print control apparatus for controlling this print apparatus generates printed image data on the basis of halftone processing, and sends the printed image data to the print apparatus. Should a highly regular pattern be used for this halftone processing, then a landing deviation can be easily recognized as a color unevenness when the image is read with, for example, a scanner.

Therefore, for example, JP-A-2005-125658 (patent document 1) discloses preventing even slight displacement of dots and preventing any major impact on image quality by causing the dots to be generated with deviation of the distribution of dots in a direction different from a direction in which a print head moves.

### SUMMARY

In a case where the dots have been generated in the manner described above, however, though the landing unevenness with respect to the direction of movement of the head can be addressed, it may not be possible to address other forms of unevenness. Moreover, it may not be possible to handle landing unevenness for every color of ink, as well. Therefore, the color unevenness is likely to be easily recognizable.

An advantage of the present invention is therefore to make the color unevenness less readily visible.

A principal invention for achieving the aforementioned objective is a print control apparatus configured to generate first printed image data indicative of positions of first dots formed by a first ink and second printed image data indicative of positions of second dots formed by a second ink, and configured to cause a print apparatus to discharge the first ink and the second ink to form the first dots and the second dots on a medium, wherein the first printed image data and the second printed image data are generated such that a preferential direction in which the first dots are generated in the first printed image data and a preferential direction in which the second dots are generated in the second printed image data are different from each other.

Other features of the present invention shall be made more readily apparent by the disclosures in the specification and accompanying drawings.

### BRIEF DESCRIPTION OF THE DRAWINGS

Referring now to the attached drawings which form a part of this original disclosure:

FIG. 1 is a block diagram illustrating a print system including a printer 1 and a computer CP;

FIG. 2A is a schematic perspective view of the printer 1, and FIG. 2B is a drawing illustrating a nozzle arrangement in a head 41;

FIG. 3 is a descriptive drawing of processing by a printer driver;

FIG. 4 is a descriptive drawing illustratively exemplifying an enlarged portion of a typical dither matrix that is consulted in dithering;

FIG. 5 is a descriptive drawing conceptually illustrating the manner in which the presence or absence of dot formation is determined for every pixel, with reference to a dither matrix;

FIGS. 6A and 6B are drawings illustratively exemplifying the manner in which dots are generated in a deviated state;

FIG. 7 is a descriptive drawing illustrating the relationship between each of the inks and a preferential direction of dot generation in the present embodiment;

FIG. 8 is a flow diagram illustrating the flow of processing for generating an appropriate dither matrix, so that the dots are generated with deviation;

FIGS. 9A and 9B are descriptive drawings illustrating a summary of image analysis using the two-dimensional Fourier transform;

FIG. 10 is a descriptive drawing conceptually illustrating a power spectrum obtained by two-dimensional Fourier transform of a typical dither matrix;

FIGS. 11A and 11B are descriptive drawings conceptually illustrating the shape of a power spectrum; and

FIGS. 12A to 12D are descriptive drawings illustrating an error diffusion matrix that is consulted in error diffusion.

### DETAILED DESCRIPTION OF EMBODIMENTS

===Overview===

At least the following matters shall be made more readily apparent by the disclosures in the present description and drawings.

A print control apparatus configured to generate first printed image data indicative of positions of first dots formed by a first ink and second printed image data indicative of positions of second dots formed by a second ink, and configured to cause a print apparatus to discharge the first ink and the second ink to form the first dots and the second dots on a medium shall be made more readily apparent, wherein the first printed image data and the second printed image data are generated such that a preferential direction in which the first dots are generated in the first printed image data and a preferential direction in which the second dots are generated in the second printed image data are different from each other.

According to such a print control apparatus, the visibility of the printed image can be improved and unevenness (moiré) can be reduced.

In the print control apparatus, preferably, the print apparatus is capable of discharging cyan ink, magenta ink, yellow ink, and black ink, and preferential directions in which cyan dots, magenta dots, yellow dots, and black dots are generated are each different.

According to such a print control apparatus, any landing unevenness for every ink color can be suppressed.

In the print control apparatus, preferably, the print apparatus is provided with a nozzle column in which nozzles for discharging the ink are arranged side by side in a predetermined direction, and a movement mechanism for causing the nozzle column and the medium to move in a relative fashion in a direction perpendicular to the predetermined direction, and the preferential direction in which the black dots are generated is the predetermined direction or the direction perpendicular to the predetermined direction.

According to such a print control apparatus, ruled lines can be easier to see.

In the print control apparatus, preferably, the preferential directions in which the cyan dots and the magenta dots are generated are directions with which the cyan dots and the magenta dots do not overlap in a region of lower gradation value than a predetermined gradation.

According to such a print control apparatus, any decrease in the color-forming performance due to overlapping of the cyan and magenta can be suppressed.

In the print control apparatus, preferably, the preferential direction in which the yellow dots are generated is between the preferential direction in which the cyan dots are generated and the preferential direction in which the magenta dots are generated.

According to such a print control apparatus, it is possible to improve the visibility of yellow, which is difficult to see.

A program shall also be made more readily apparent for causing a print control apparatus that is configured to generate first printed image data indicative of positions of first dots formed by a first ink and second printed image data indicative of positions of second dots formed by a second ink and that is configured to cause a print apparatus to discharge the first ink and the second ink to form the first dots and the second dots on a medium, to execute processing for generating the first printed image data and the second printed image data such that a preferential direction in which the first dots are generated in the first printed image data and a preferential direction in which the second dots are generated in the second printed image data are different from each other.

An image processing method for generating first printed image data indicative of positions of first dots formed on a medium by a first ink discharged by a print apparatus and second printed image data indicative of positions of second dots formed on the medium by a second ink discharged by the print apparatus shall be made more readily apparent, wherein the first printed image data and the second printed image data are generated such that a preferential direction in which the first dots are generated in the first printed image data and a preferential direction in which the second dots are generated in the second printed image data are different from each other.

### First Embodiment

### Description of Terminology

First, the meaning of terminology used when describing the present embodiment shall be described.

A “printed image” refers to an image that is printed on paper. A printed image of an inkjet printer is constituted of countless dots formed on the paper.

“Image data” refers to data that is indicative of a two-dimensional image. In the embodiments described below, this includes image data for an RGB color space, image data for a CMYK color space, and the like. The image data of each of the colors of a CMYK color space is in some instances called “C image data”, “M image data”, “Y image data”, and “K image data”, respectively. Image data also includes image data of 256 gradations, image data of four gradations, and the like. In a case where a printer forms dots at four gradations (large dot, medium dot, small dot, no dot), then image data of four gradations in a CMYK color space would be indicative of the state of formation of the dots constituting the printed image, and therefore image data of four gradations in a CMYK color space is in particular also called “printed image data” in some instances. A “pixel” refers to the smallest unit constituting an image. An image is configured when these pixels are arranged in two dimensions. The meaning is principally for pixels in image data.

“Pixel data” refers to data that is indicative of gradation values for pixels. Image data would be constituted of a large amount of pixel data. Pixel data is in some instances also called “gradation values for pixels”.

The meaning of generic terms such as “image data” or “pixel” shall be interpreted as appropriately, along not only the description above but also the common knowledge that is typical in the art.

<Configuration of the Print System>

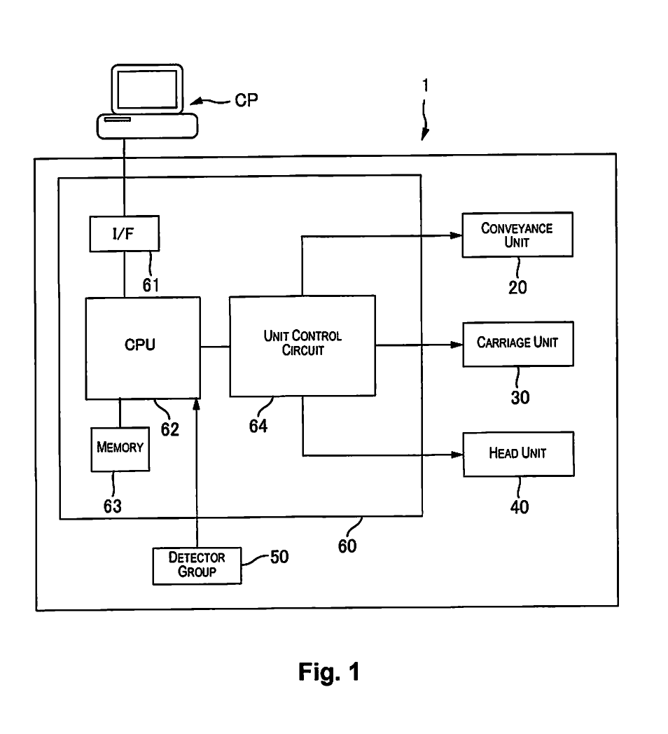

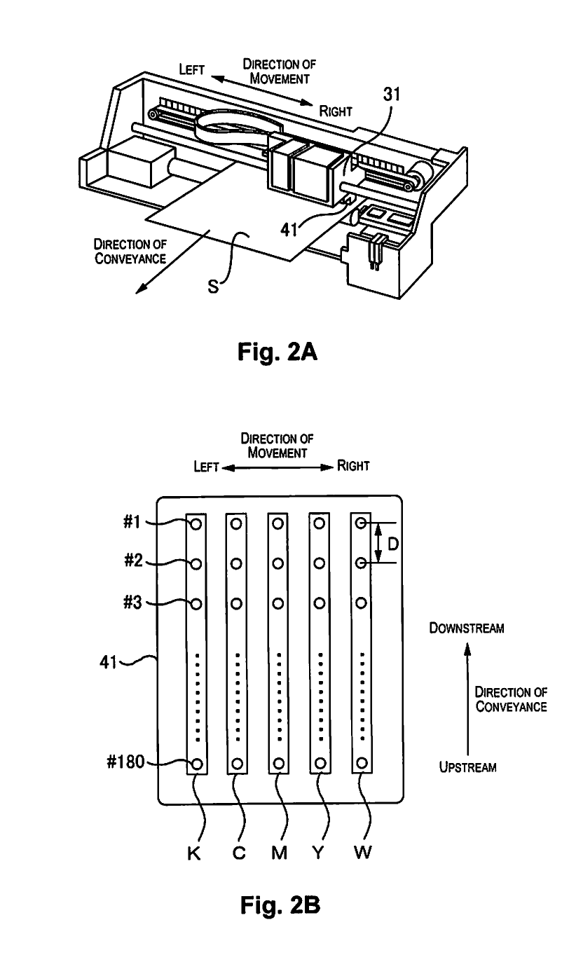

FIG. 1 is a block diagram illustrating a print system including a printer 1 and a computer CP. FIG. 2A is a schematic perspective view of the printer 1, and FIG. 2B is a drawing illustrating a nozzle arrangement in a head 41. The printer 1 discharges ink, which is one type of liquid, toward a medium such as paper, cloth, or film.

The computer CP is communicably connected to the printer 1. In order to cause the printer 1 to print an image, the computer CP transmits printed image data corresponding to that image to the printer 1. A printer drive is installed on the computer CP. The printer driver is a program for causing a display apparatus (not shown) of the computer CP to display a user interface (UI), causing the computer CP to implement a color conversion process or the like, and so forth. This printer drive is stored on a recording medium (a computer-readable recording medium) such as a flexible disk FD or a CD-ROM. Alternatively, the printer driver could also be downloaded onto the computer CP via the Internet. This program is constituted of a code for implementing a variety of functions. The processing by the printer driver shall be described below.

A “print apparatus” signifies an apparatus for printing an image onto a medium; an applicable example is the printer 1. A “print control apparatus” signifies an apparatus for controlling a print apparatus; an applicable example is the computer CP onto which the printer driver has been installed.

The printer 1 has a conveyance unit 20, a carriage unit 30, a head unit 40, a detector group 50, and a controller 60.

The conveyance unit 20 is for feeding the medium (here, a paper S) to a position at which printing is possible, and conveying the paper S by a predetermined conveyance amount in a direction of conveyance during printing.

The carriage unit 30 is for moving the head 41 in a direction (hereinafter called a direction of movement) intersecting with the direction of conveyance, and has a carriage 31.

The head unit 40 is for discharging the ink onto the paper S, and has a head 41. The head 41 is moved in the direction of movement by the carriage 31. Provided to a lower surface of the head 41 are a plurality of nozzles, which are ink discharge sections. FIG. 2B is a drawing where the arrangement of the nozzles is viewed virtually from an upper surface of the head 41. As is depicted, four nozzle columns are formed, with 180 nozzles arranged side by side at a predetermined interval D in the direction of conveyance. A black nozzle column K for discharging black ink, a cyan nozzle column C for discharging cyan ink, a magenta nozzle column M for discharging magenta ink, and a yellow nozzle column Y for discharging yellow ink are arranged side by side in the stated order from the left in the direction of movement. Each of the nozzles of the head 41 has a correspondingly arranged piezoelectric element (not shown). Then, on the basis of when a piezoelectric element is actuated by a drive signal, it becomes possible to discharge ink from the corresponding nozzle.

The detector group 50 is constituted of a plurality of detectors for monitoring the status of the printer 1. Results of detection by these detectors are outputted to the controller 60.

The controller 60 performs overall control of the printer 1. The controller 60 has an interface section 61, a CPU 62, and a memory 63. The interface section 61 transfers data to and from the computer CP. The memory 63 is for securing a region for storing the programs of the CPU 62, a work region, and the like, and has a storage element such as a RAM or EEPROM. The CPU 62 controls each of the units in accordance with a computer program stored in the memory 63.

In the printer 1 of such description, the controller 60 repeatedly executes: a dot formation process for intermittently discharging ink from the head 41 while also moving the carriage 31 in the direction of movement, thus forming dots on the paper; and a conveyance process for conveying the paper S in the direction of conveyance. As a result, the dots are formed at positions different from the positions of the dots formed by the preceding dot formation process, thus causing a two-dimensional image to be printed on the paper S.

<Overview of the Processing of the Printer Driver>

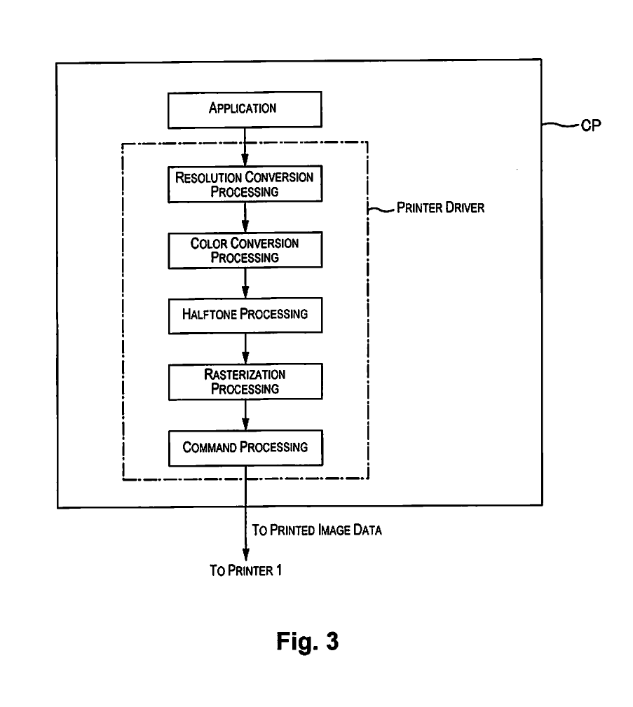

The aforementioned print process is initiated by which the printed image data is transmitted from the computer CP connected to the printer 1. The printed image data is created by the processing by the printer driver. The processing by the printer driver shall now be described below, with reference to FIG. 3. FIG. 3 is a descriptive drawing of the processing by the printer driver.

Image data before color conversion processing is image data of 256 gradations in an RGB color space. The printer driver, where necessary, performs resolution conversion processing prior to the color conversion processing so that the resolution of the input image data fits the print resolution. For example, in a case where the resolution of the image data received from an application program is 600 dpi×600 dpi and the print resolution is 1200 dpi×600 dpi, then the 600 dpi×600 dpi is converted to 1200 dpi×600 dpi.

Next, the printer driver performs color conversion processing for converting the image data in an RGB color space into image data in a CMYK color space, which is the same color space as the ink colors. This color conversion processing is carried out by when the printer driver consults a table (a color conversion look-up table) in which gradation values of pixel data in an RGB color space and gradation values of pixel data in a CMYK color space are associated. The image data after color conversion processing is image data of 256 gradations in a CMYK color space.

Following the color conversion processing, the printer driver performs halftone processing for converting the image data of 256 gradations into image data of four gradations, which are the gradations that the printer is capable of forming. Dithering, y correction, error diffusion, or the like is utilized in the halftone processing. The image data after halftone processing will be printed image data indicative of the statuses of formation (presence or absence of a dot, size of the dot) of the dots constituting the printed image.

Following the halftone processing, the printer drive transmits the printed image data to the printer 1. When transmitting the printed image data to the printer 1, the printer driver may carry out rasterization processing for converting the order in which the pixel data of the printed image data is arranged, command addition processing for adding command data necessary for the control of the printer 1 to the printed image data, or the like, as necessary.

Having received the printed image data, the printer 1 discharges the ink from each of the nozzles of the head 41 and forms the dots in a pixel region on the paper S in accordance with the gradation values indicated by the pixel data of the printed image data. This makes it possible for the printer 1 to print the image indicated by the printed image data onto the paper S.

In the following description, the decision to form a dot at a given pixel by the halftone processing (the generation of pixel data indicative of the formation of a dot) is also discussed as being the generation of a dot. Also, the following description assumes that only the presence or absence of the formation of a dot is decided (i.e., assumes that halftone processing for converting to image data of two gradations is carried out), for the purpose of simplifying the description, but a case of conversion to image data of four gradations that also includes the size of the dots could also be carried out in a similar manner.

<Challenges in the Halftone Processing>

In a case where the halftone processing described above is carried out using, for example, a highly regular dither pattern, then landing deviation tends to be very visible in the form of a color unevenness. Also, the extent to which the landing deviation makes the color unevenness visible varies depending on the color of the ink. For this reason, there is the possibility that the image quality could decline for every color when, for example, scanning is performed sequentially in RBG in copying or the like.

Therefore, in the present embodiment, during the halftone processing, every color is made to have a different preferential direction for the generation of dots. This reduces the color unevenness (moiré).

On the Definition of the Preferential Direction for the Generation of Dots

As stated above, in the halftone processing, it would be possible to apply a technique such as dithering or error diffusion, but herein the description assumes that dithering is used. In dithering, the generation of the dots is decided by comparing, for every pixel, the gradation value of the image data with a threshold value that is set in a dither matrix.

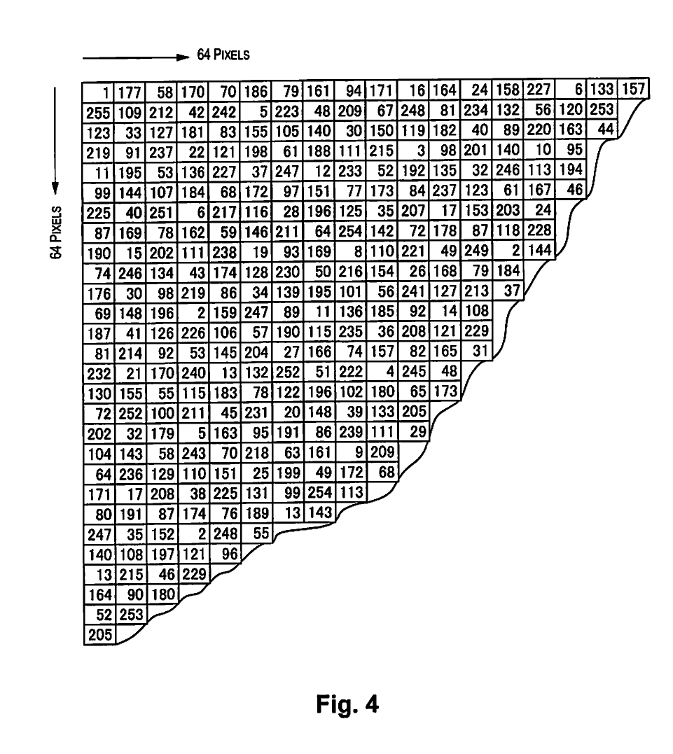

FIG. 4 is a descriptive drawing illustratively exemplifying an enlarged portion of a typical dither matrix that is consulted in dithering. In the matrix depicted, threshold values that have been evenly selected from the range of gradation values 0 to 255 have been set for 64 pixels vertically and 64 pixels horizontally, giving a total of 4,096 pixels. The size of the dither matrix, however, is not limited to being 64 pixels by 64 pixels, as is illustratively exemplified in FIG. 4, but rather a variety of sizes would be possible, including those where the vertical and horizontal numbers of pixels are different.

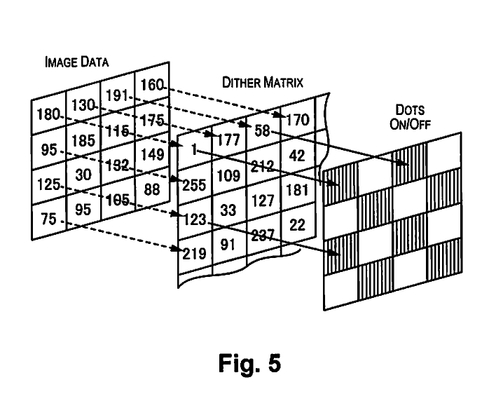

FIG. 5 is a descriptive drawing conceptually illustrating the manner in which the presence or absence of dot formation is determined for every pixel, with reference to the dither matrix. When the presence or absence of dot formation is being decided, first the gradation value of the image data for a pixel (target pixel) being targeted as the subject of determination and the threshold value that is stored at the corresponding position in the dither matrix are compared. The thin broken-line arrows illustrated in the drawing are schematic representations of when the gradation values of target pixels are compared with the threshold values that are stored in the corresponding positions in the dither matrix. In a case where the gradation value of the target pixel is larger than the threshold value of the dither matrix, then a determination is made to form a dot for that pixel. Conversely, in a case where it is the threshold value of the dither matrix that is larger, then a determination is made not to form a dot for that pixel.

In the example illustrated in FIG. 5, the image data for the pixel that is in the upper left corner of the image data is a gradation value 180, and the threshold value that is stored in the position corresponding to this pixel in the dither matrix is 1. As such, because the gradation value of 180 in the image data is larger than the threshold value of 1 in the dither matrix for the pixel in the upper left corner, a determination is made to form a dot for this pixel. The arrows illustrated with solid lines in FIG. 5 are schematic representations of the manner in which the determination is made to form a dot for the pixel and the determination result is stored. For the pixel to the right of this pixel, however, the gradation value in the image data is 130 and the threshold value in the dither matrix is 177; because it is the threshold value that is larger, a determination is made not to form a dot for this pixel. Dithering in this manner causes dots to be generated by consulting a dither matrix.

In the halftone processing (see FIG. 3) of the present embodiment, as well, as with typical dithering, the dots are generated by determining the presence or absence of dot formation for every pixel by consulting the dither matrix. The dither matrix that is consulted in the present embodiment, however, is not a matrix in which threshold values have been simply evenly set, but rather is a special dither matrix in which the threshold values have been set using a method described below. The dither matrix is prepared for every ink color. Consulting such a dither matrix makes it possible to generate the dots in a deviated state.

The significance of “generating the dots in a deviated state” shall be described herein.

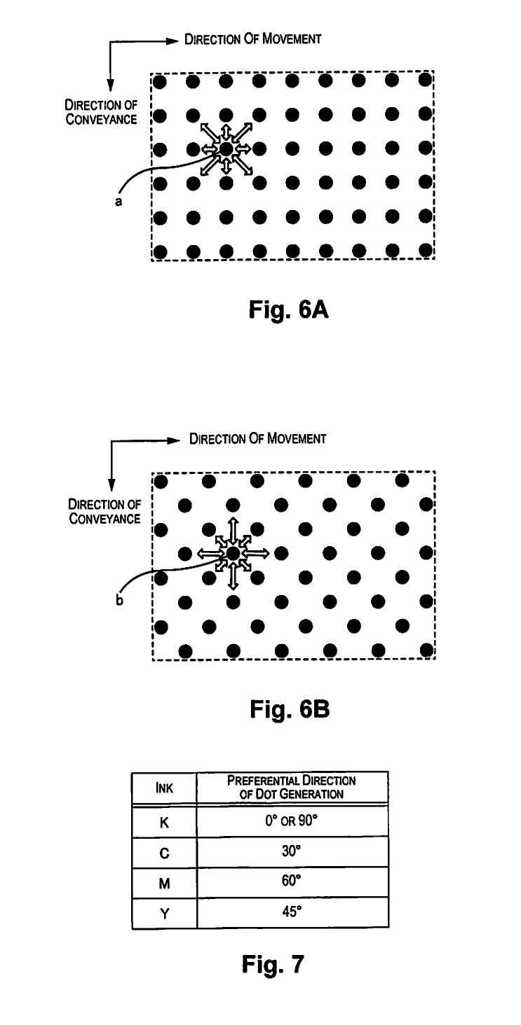

FIGS. 6A and 6B are drawings illustratively exemplifying the manner in which dots are generated in a deviated state. First, FIG. 6A shall be described. In FIG. 6A, when the entire region is observed, the dots have been formed uniformly and at a constant density, and there exists no region where a plurality of dots have been formed especially close to one another. However, upon observation focusing on individual dots, the dots have not necessarily been generated uniformly in all directions.

For example, when the focus is on the dot a in FIG. 6A, there are eight dots present in the vicinity of the dot a, but these eight dots have not necessarily been formed a substantially equal distance. That is, the dots that are in the direction of movement or the direction of conveyance have been formed closer, and the dot that are at a 45° angle from these directions have been formed farther away. This property whereby dots in the direction of movement and the direction of conveyance have been formed closer and dots at a 45° angle from these directions have been formed farther away is not a property limited to the dot a, but rather is a property that likewise applies to all of the dots in FIG. 6A. That is, the dots illustrated in FIG. 6A have not been generated uniformly in all directions, but rather can be thought of as having been generated in a deviated manner, where the dots are denser in the direction of movement and the direction of conveyance and the dots are sparser in the 45° directions.

The example illustrated in FIG. 6A displays a case where all of the dots possess entirely the same property as the dot a, i.e., the property whereby the dots have been generated in a deviated manner, where the dots are denser in the direction of movement and the direction of conveyance and the dots are sparser in the 45° directions. However, there is no need for all of the dots to necessarily possess the same property; a case in which a plurality of dots each possess different properties could still be thought of as having generation of dots that is deviated, provided that there be some kind of property when these dots are viewed as a whole. The question of what kind of property there is when a plurality of dots are viewed as a hole can be easily detected by applying a variety of statistical analytical techniques, such as applying a two-dimensional Fourier analysis to the image to detect the power spectrum, or performing a correlation analysis and calculating the autocorrelation coefficient. A deviated state of the dots refers to such a state in which, when the dots that have been generated in a given range are viewed as a whole, the dots have not been generated uniformly in all directions but rather the dots have been generated so as to be denser or sparser depending on the direction.

In FIG. 6B, the dots that are in the direction of movement or the direction of conveyance have been formed farther away (in other words, the dots are sparser), and the dots that are at a 45° from these directions have been formed closer (in other words, the dots are denser). This means that for FIG. 6B, as well, as with FIG. 6A, the dots have been generated in a deviated state.

Therefore, the concept of “direction of deviation” shall be introduced in order to distinguish between the two states. A case in which dots have been generated in a denser state in the direction of movement (or in the direction of conveyance), for example, such as illustrated in FIG. 6A, shall be expressed by stating that “the dots have been generated with deviation in the direction of movement (or the direction of conveyance)”. The description that follows assumes that the direction of movement (downstream side) shall be “0°”, and assumes that in such a case, the preferential direction of dot generation shall be “0° (or 90°)”.

The case illustrated in FIG. 6B, in turn, shall be expressed by stating that “the dots have been generated with deviation in the direction of a 45° angle from the direction of movement (or the direction of conveyance)”. With such a case, it is assumed that the preferential direction of dot generation shall be “45°”.

<On the Preferential Direction of Dot Generation in the Present Embodiment>

As stated above, in the present embodiment, the halftone processing involves causing the preferential direction for the generation of dots to be different for every color.

FIG. 7 is a descriptive drawing illustrating the relationship between each of the inks and the preferential direction of dot generation in the present embodiment.

For example, for black, the preferential direction of dot generation is understood to be “0° (or 90°)”. The reason for having the preferential direction of black be “0° (or 90°)” is that the ruled lines are being taken into consideration. The ruled lines appear neatly when the ruled lines are formed with black in a case where the preferential direction of dot generation is “0° (or 90°)”.

For cyan and magenta, as well, the respective preferential directions are given the greatest possible angle. Herein, the preferential direction of dot generation for cyan is “30°”, and the preferential direction of dot generation for magenta is “60°”. So doing makes it possible to curb any deterioration of the color-producing performance, with no overlapping of the cyan and magenta dots, when the region is one of low gradation. Cyan and magenta may also have inverse preferential directions of dot generation.

For yellow, the preferential direction of dot generation is the angle between the preferential direction of dot generation for cyan and the preferential direction of dot generation for magenta. Herein, the preferential direction of dot generation for yellow is “45°”. This is because cyan and magenta are easily visible and yellow is less easily visible. Having the preferential direction of dot generation for yellow be the angle between the preferential direction of dot generation for cyan and the preferential direction of dot generation for magenta, as per the present embodiment, makes it possible to improve the visibility of yellow.

In this manner, in the present embodiment, the C image data, M image data Y image data, and K image data indicative of the dot formation positions for each of the inks are each generated by changing the preferential direction of dot generation for every ink color in CMYK. The inks are then discharged from the nozzles of each of the nozzle columns of the head 41 of the printer 1 on the basis of the C image data, M image data, Y image data, and K image data created in this manner.

So doing makes it possible to improve the visibility of the printed image and makes it possible to reduce unevenness (moiré).

<Method of Generating the Dither Matrix>

As described above, in the computer CP of the present embodiment, the dots are generated in a deviated state for every ink color in order to improve the visibility of the image printed by the printer 1. Such a distribution of dots can be obtained by consulting a special dither matrix in which the threshold values are not simply evenly set, as with a typical dither matrix, but rather the threshold values are set with a special method so that the dots are generated with deviation. Therefore, the processing for generating this dither matrix shall be described below.

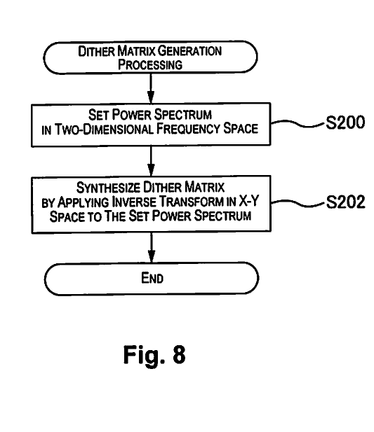

FIG. 8 is a flow diagram illustrating the flow of processing for generating an appropriate dither matrix, so that the dots are generated with deviation. The following description is in reference to FIG. 8.

When the dither matrix generation processing is initiated, first, a power spectrum is set in a two-dimensional frequency space (S200). As preparation for describing the content of this processing, first a technique for analyzing an image by using the two-dimensional Fourier transform shall be briefly described.

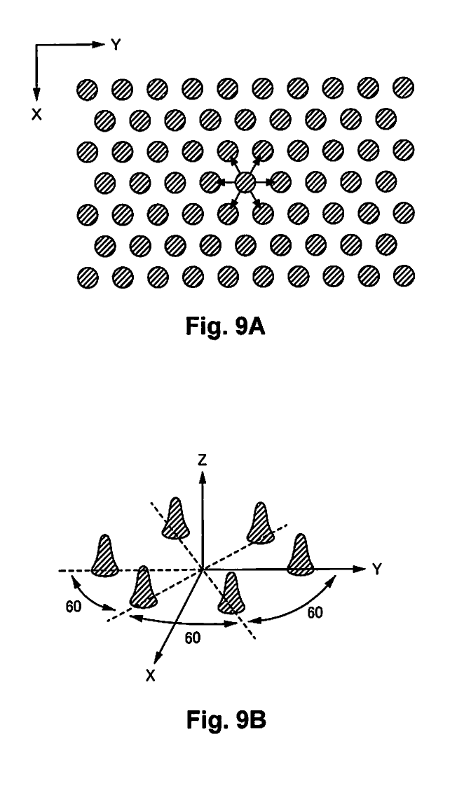

FIGS. 9A and 9B are descriptive drawings illustrating a summary of image analysis using the two-dimensional Fourier transform. An image such as is illustrated in FIG. 9A shall be considered by way of example. This image possesses periodicity in six directions that intersect with one another at an angle of 60°. The periodicity of such an image can be assessed by applying the two-dimensional Fourier transform to the image.

The two-dimensional Fourier transform of an image can be understood as being simply a two-dimensional extension of the one-dimensional Fourier transform, when considered as follows. For example, when the Fourier transform is applied to one-dimensional data that is converted over time, as with a voltage waveform or the like, then the original voltage waveform can be broken down into sine waves of various frequency components. Herein, the reason why the components obtained when the Fourier transform is carried out will be the components of every frequency is because with this data, the original voltage waveform changes with time. That is to say, the components obtained by applying the Fourier transform will be components having the reciprocal of the data intended to be converted, and therefore in a case where the Fourier transform is applied to data that changes over time, frequency components that have a dimension that is the reciprocal of time are obtained.

Similarly, in a case where the Fourier transform is applied to data that changes with distance, then the data is converted into components called wave numbers or spatial frequencies, which have a dimension that is the reciprocal of the distance. The components of the spatial frequencies thus obtained have the following properties. Namely, the more slowly the data being converted changes with distance, the greater the values of components having a small spatial frequency. Conversely, in a case where the Fourier transform is applied to data that changes rapidly with distance, then the values of components that have a large spatial frequency will be larger.

Herein, the data of the image can be regarded as being data that changes with distance in two direction (for example, the X-direction and the Y-direction). As such, the Fourier transform can be applied to this two-dimensional data with respect to the X-direction and the Y-direction each. With this two-dimensional Fourier transform, spatial frequency components in the X-direction are obtained for changes in the X-direction, and spatial frequency components in the Y-direction are obtained for changes in the Y-direction. The two-dimensional Fourier transform of an image thus can be regarded as being a procedure for applying the Fourier transform in two direction and obtaining the spatial frequency components in each of the directions. Applying the two-dimensional Fourier transform to an image then makes it possible to assess the periodicity of the image.

The data for the image illustrated in FIG. 9A is data with which the gradation values change along with the movement of the positions in the X-direction and the Y-direction. As such, the two-dimensional Fourier transform can be applied to obtain the spatial frequency components for the X-direction and the Y-direction. FIG. 9B is a graph representing the magnitude of each of the components obtained in this manner. Such a graph, which represents the magnitude of each of the components, is often referred as a power spectrum. The graph in FIG. 9B displays the spatial frequencies in the X-direction on the X-axis, and displays the spatial frequencies in the Y-direction on the Y-axis. This coordinate system, which displays the spatial frequencies in the X-direction on the X-axis and displays the spatial frequencies in the Y-direction on the Y-axis, is in the present specification sometimes also called a two-dimensional spatial frequency coordinate system or simply a two-dimensional frequency space.

As stated above, the image in FIG. 9A has periodicity in six directions that intersect with one another at an angle of 60°, and, correspondingly thereto, six peak components appear in the power spectrum of the two-dimensional frequency space. Corresponding to the fact that the image before the Fourier transform has periodicity in directions differing from one another by 60° increments, the six peaks of the power spectrum also appear in directions differing from one another by 60° increments, centered on the origin. The distance from the origin of the frequency space to each of the peaks is representative of the spatial frequency component in each of the directions, and this corresponds to the distance between dots that are adjacent in each of the directions on the image before the transform. That is to say, the closer the distance between dots in the image in FIG. 9A, the farther from the origin the position at which the peaks of the power spectrum illustrated in FIG. 9B are generated, and conversely the farther the distance between dots, the closer the peaks of the power spectrum will be generated to the origin. Also, the greater the density of dots in the image in FIG. 9A (the greater the gradation values of the image data), the greater the height of the peaks, and the greater the diameter of the dots, the wider the base of the shape taken by the peaks. In this manner, the power spectrum obtained by applying the Fourier transform to the original image in a two-dimensional frequency space will be one that corresponds closely to the original image, and conversely, when the inverse Fourier transform is applied, it is possible to synthesize the original image from the power spectrum in the two-dimensional frequency space.

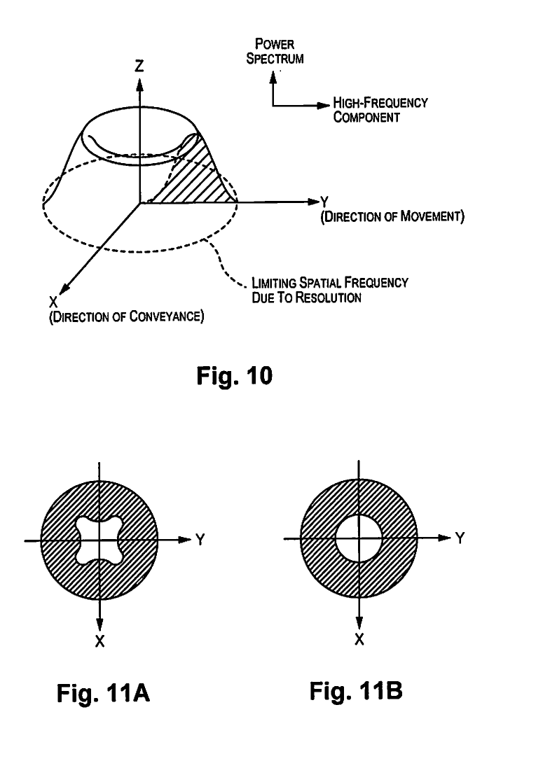

FIG. 10 is a descriptive drawing conceptually illustrating a power spectrum obtained by two-dimensional Fourier transform of a general dither matrix that is typically used. As stated above, the threshold values have been set in the form of a matrix in the dither matrix. Therefore, when the threshold values are read as data and the two-dimensional Fourier transform is applied, the power spectrum of the dither matrix can be obtained.

Herein, as has been described with reference to FIG. 9, the power spectrum is such that the farther a component is from the origin of the frequency space, the shorter the period of the fluctuation. The dither matrix does not, however, contain any fluctuation having a period shorter than a pixel. Therefore, the power spectrum of the dither matrix contains a limiting spatial frequency corresponding to the size of the pixel, and the power spectrum will always be “0” in the region greater than this limiting spatial frequency. The dither matrix has been set so that the dots are generated as sparsely as possible, and correspondingly, the power spectrum of the dither matrix has a low value in a region where the spatial frequency is low. Consequently, the power spectrum of a typical dither matrix takes a substantially discoid shape, with a significantly recessed middle, as illustrated in FIG. 10. Conversely when the inverse Fourier transform is applied with the power spectrum as illustrated in FIG. 10 having been set in the two-dimensional frequency space, then it becomes possible to synthesize a general dither matrix.

On the basis of the above description, the processing in step S200 in FIG. 8 shall now be described. In this processing, a power spectrum is set as illustrated in FIG. 10 in the two-dimensional frequency space. With a general dither matrix, an attempt is made to generate the dots evenly so as not to deviate, and therefore in the vicinity of the center, the shape of the power spectrum is recessed in the same manner in all directions.

By contrast, with the dither matrix of the present embodiment, the dots are being generated with deviation. For example, in a case where the preferential direction of dot generation is “45°”, as per FIG. 6B, then the dots will be sparse in the direction of movement and the direction of conveyance. When the dots are sparse, there is a greater distance between adjacent dots. As such, to generate the dots so as to be sparse in the direction of movement and the direction of conveyance, it suffices to generate the power spectrum from low spatial frequencies for these directions. That is to say, for the power spectrum illustrated in FIG. 10, it suffices to set a power spectrum such that the depression of the middle portion is smaller in the direction of movement and the direction of conveyance.

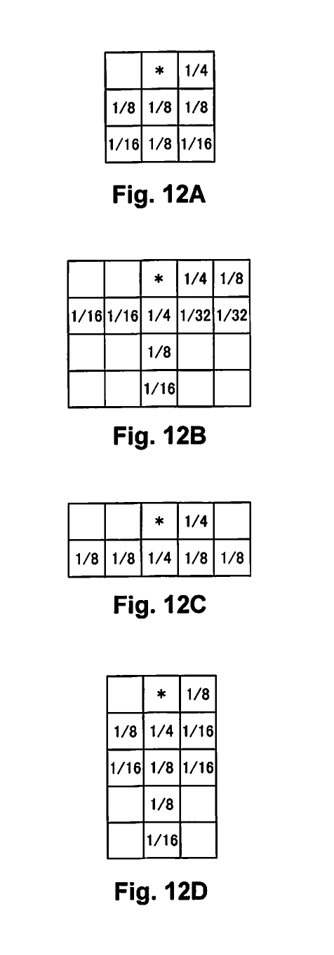

FIGS. 11A and 11B are descriptive drawings conceptually illustrating the shape of the power spectrum. In order to clearly represent the shape of the depression of the middle portion, a cross-sectional shape obtained when the power spectrum is cut in a plane parallel to the XY coordinate plane is illustrated; FIG. 11A illustrates the power spectrum of the dither matrix for when the preferential direction of dot generation is “45°”. FIG. 12B illustrates the power spectrum of a typical dither matrix (when the dots are formed evenly) such as is illustrated in FIG. 10, as a reference. In the step S200 in FIG. 8, the processing for setting the power spectrum of a shape corresponding to the preferential direction of dot generation is performed for every ink color.

Setting the power spectrum in this manner makes it possible to synthesize the dither matrix by later applying the inverse Fourier transform to this spectrum (S202). When the dots are generated while consulting the dither matrix thus synthesized, it becomes possible to generate the dots preferentially in a particular direction.

In this manner, having set the power spectrum corresponding to the preferential direction of dot generation and applying the Fourier transform to this spectrum makes it possible to produce a dither matrix for generating dots in the preferential direction.

The description above posts that the power spectrum is the spectrum that is obtained when the two-dimensional Fourier transform is applied. In the Fourier transform, the transformation uses a sine function and cosine function as basis functions. However, the functions that can be used as basis functions are not limited to a sine function and cosine function; recently, the so-called wavelet transform, in which a wavelet function is used as the basis function, has also been put to use. The description given above can be similarly applied to an instance where a wavelet transform is used. That it so say, a power spectrum obtained by a wavelet transform of a dither matrix is set, and an appropriate dither matrix is produced by applying the inverse wavelet transform thereto. When the dots are generated by consulting the dither matrix produced in this manner, it becomes possible to print a high-quality image, without comprising the image quality, even in a case where the positions of dot formation have been shifted somewhat.

As described above, in the present embodiment, the printed image data of each of the colors is generated with there being a difference created for the preferential direction of dot generation for every ink color (CMYK). This makes it possible to improve the visibility of the printed image and makes it possible to reduce any unevenness (moiré).

### Second Embodiment

In the first embodiment, the dots were generated by consulting a dither matrix. However, the method of generating the dots is not limited to dithering. In the second embodiment, an example where error diffusion has been applied shall be described.

FIGS. 12A to 12D are descriptive drawings illustrating an error diffusion matrix that is consulted in error diffusion. As stated above, error diffusion comprises determining whether or not to form a dot for a pixel of interest, and diffusing the error of gradation expression caused thereby to pixels not yet determined in the periphery. When the presence or absence of dot formation is determined for pixels not yet determined, the dots are generated by determining the presence or absence of dot formation so that the error that has been diffused from the periphery is eliminated. In an error diffusion matrix, a ratio by which the error generated in a pixel of interest is diffused to pixels in the periphery has been set, and error diffusion comprises diffusing the error to the pixels in the periphery by consulting the error diffusion matrix.

In typical error diffusion, the dots are generated evenly and uniformly, and therefore an error diffusion matrix such as is illustrated in FIG. 12A is used. The pixel illustrated with “*” in FIG. 12A illustrates the pixel of interest. According to this error diffusion matrix, ¼ of the generated error is diffused into the adjacent pixel to the right of the pixel of interest and ⅛ of the error is diffused into each of the two pixels that are below the pixel of interest. When the error is diffused in accordance with such an error diffusion matrix, the error is diffused substantially uniformly into the pixels not yet determined in the periphery, and therefore, as a result, the dots can be evenly generated.

By contrast, when an error diffusion matrix such as is illustrated in FIGS. 12B to 12D is used, the dots can be generated with preference given to a predetermined direction. For example, in a case where the error diffusion matrix of FIG. 12B is used, the error generated in the pixel of interest is not diffused in the oblique directions, but rather is diffused principally in the lateral direction (the direction of movement) and the longitudinal direction (the direction of conveyance). As stated above, error diffusion is a technique for determining the presence or absence of dot formation so as to eliminate the error that has been diffused from the periphery, and therefore when the error is diffused principally in the direction of movement and the direction of conveyance, the dots can be prevented from being generated in these directions. When an error diffusion matrix such as is illustrated in FIG. 12C is used, the error is principally diffused in the direction of movement, and when a matrix such as in FIG. 12D is used, the error is principally diffused in the direction of conveyance. As a result, the dots can be prevented from being generated in the direction of movement or the direction of conveyance, respectively.

In this manner, changing the setting of the error diffusion matrix makes it possible to generate the dots with preference given to a particular direction. Accordingly, it suffices to set the error diffusion matrix so that the dots are generated in the preferential direction described above, for every ink color.

As described above, in a case where error diffusion is applied as the technique for generating the dots, too, the dots can be generated with deviation when an appropriate error diffusion matrix is used in this manner. Accordingly, changing the preferential direction of dot generation for every ink color makes it possible to improve the visibility of the printed image and makes it possible to reduce any unevenness (moiré).

### Other Embodiments

The embodiments above are intended to facilitate understanding of the present invention, and are not to be construed as limiting the present invention. It shall be readily understood that the present invention can also be modified or improved without departing from the spirit thereof, and that the present invention encompasses equivalents thereof. In particular, the present invention also encompasses the embodiments described below.

<Regarding the Printer>

The printer 1 of the embodiments described above was a serial-type printer, but there is no limitation thereto, and the printer may be a printer of another format. For example, the printer may be a so-called line printer, which is a print apparatus with which a head (nozzle columns) longer than the paper width is fixed onto the conveyance path, and the ink is continuously discharged from the head to print onto the medium while the medium is being conveyed in the direction of conveyance.

<Regarding the Format of Discharge>

In the embodiments described above, the ink was discharged using piezoelectric elements (piezo elements). However, the format of discharging the ink is in no way limited thereto. Other formats may be used, e.g., a format where heat is used to generate bubbles inside the nozzles, or the like.

<Regarding the Print Control Apparatus>

In the embodiments described above, the halftone process was carried out by the printer driver of the computer CP, but there is no limitation thereto. For example, the printer may be capable of halftone processing. In such a case, a site (for example, a controller) at which the halftone processing is carried out in the printer would be applicable as a print control apparatus, and a site at which printing is carried out (the head unit, conveyance unit, or the like) would be applicable as a print apparatus.

<Regarding the Ink>

In the embodiments described above, four colors of ink were used—cyan, magenta, yellow, and black—but there is no limitation thereto. For example, four other colors of color ink (orange ink, red ink, or the like) may also be used. In such a case, too, it suffices for the preferential direction of dot generation to be defined for every color of ink.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A print control apparatus configured to generate first printed image data indicative of positions of first dots formed by a first ink and second printed image data indicative of positions of second dots formed by a second ink, and configured to cause a print apparatus to discharge the first ink and the second ink to form the first dots and the second dots on a medium,
wherein the first printed image data and the second printed image data are generated such that a preferential direction in which the first dots are generated in the first printed image data and a preferential direction in which the second dots are generated in the second printed image data are different from each other.

2. The print control apparatus as set forth in claim 1, wherein
the print apparatus is configured to discharge cyan ink, magenta ink, yellow ink, and black ink, and
preferential directions in which cyan dots, magenta dots, yellow dots, and black dots are generated are different from each other.

3. The print control apparatus as set forth in claim 2, wherein
the print apparatus includes a nozzle column in which nozzles that is configured to discharge ink are arranged in a predetermined direction, and a movement mechanism that is configured to move the nozzle column and the medium relative to each other in a direction perpendicular to the predetermined direction, and
the preferential direction in which the black dots are generated is the predetermined direction or the direction perpendicular to the predetermined direction.

4. The print control apparatus as set forth in claim 2, wherein
the preferential directions in which the cyan dots and the magenta dots are generated are directions with which the cyan dots and the magenta dots do not overlap in a region of lower gradation value than a predetermined gradation.

5. The print control apparatus as set forth in claim 4, wherein
the preferential direction in which the yellow dots are generated is between the preferential direction in which the cyan dots are generated and the preferential direction in which the magenta dots are generated.

6. A non-transitory computer readable medium having stored thereon a program for causing a print control apparatus that is configured to generate first printed image data indicative of positions of first dots formed by a first ink and second printed image data indicative of positions of second dots formed by a second ink and that is configured to cause a print apparatus to discharge the first ink and the second ink to form the first dots and the second dots on a medium,
to execute processing for generating the first printed image data and the second printed image data such that a preferential direction in which the first dots are generated in the first printed image data and a preferential direction in which the second dots are generated in the second printed image data are different from each other.

7. An image processing method for generating first printed image data indicative of positions of first dots formed on a medium by a first ink discharged by a print apparatus and second printed image data indicative of positions of second dots formed on the medium by a second ink discharged by the print apparatus,
wherein the first printed image data and the second printed image data are generated such that a preferential direction in which the first dots are generated in the first printed image data and a preferential direction in which the second dots are generated in the second printed image data are different from each other.
